(19) United States
(12) Patent Application Publication
(10) Pub. No.: US 2025/0238100 A1
(43) Pub. Date: Jul. 24, 2025

(54) ELECTRONIC DEVICE AND METHOD FOR CORRECTING TYPOGRAPHICAL ERROR OF KEYBOARD INPUT

(71) Applicant: Samsung Electronics Co., Ltd., Suwon-si (KR)

(72) Inventors: Jiseong GU, Suwon-si (KR); Heewon KIM, Suwon-si (KR); Byoungwook YANG, Suwon-si (KR); Bosung KIM, Suwon-si (KR); Sangheon KIM, Suwon-si (KR); Junsung KIM, Suwon-si (KR); Seoghee JEONG, Suwon-si (KR); Yeunwook LIM, Suwon-si (KR)

(21) Appl. No.: 19/173,189

(22) Filed: Apr. 8, 2025

Related U.S. Application Data
(63) Continuation of application No. PCT/KR2023/015868, filed on Oct. 13, 2023.

(30) Foreign Application Priority Data
Oct. 14, 2022 (KR) 10-2022-0132323
Jan. 31, 2023 (KR) 10-2023-0012892

(51) Int. Cl. G06F 3/041; G06F 3/04883; G06F 3/04886

(52) U.S. Cl. CPC G06F 3/0418; G06F 3/0412; G06F 3/04883; G06F 3/04886

(57) ABSTRACT

An electronic device is provided. The electronic device includes a display including a touch screen, memory storing one or more computer programs, and one or more processors including processing circuitry communicatively coupled to the display and the memory, wherein the one or more computer programs include computer-executable instructions that, when executed by the one or more processors individually or collectively, cause the electronic device to control the display to display a keyboard in response to an application being executed, based on receiving a touch input from the keyboard, collect context data related to the touch input and store the collected context data in the memory, based on the collected context data, generate statistical data of the key being input and store the statistical data in the memory, based on the statistical data of the key being input and stored in the memory, analyze movement of the touch input and adjust a touch move sensitivity value based on a result of the analysis, based on the adjusted touch move sensitivity value, identify a key corresponding to a touch-down position or a touch-up position of the touch input as an input key, and process input of a character corresponding to the input key.

CROSS-REFERENCE TO RELATED APPLICATION(S)

This application is a continuation application, claiming priority under 35 U.S.C. § 365 (c), of an International application No. PCT/KR2023/015868, filed on Oct. 13, 2023, which is based on and claims the benefit of a Korean patent application number 10-2022-0132323, filed on Oct. 14, 2022, in the Korean Intellectual Property Office, and of a Korean patent application number 10-2023-0012892, filed on Jan. 31, 2023, in the Korean Intellectual Property Office, the disclosure of each of which is incorporated by reference herein in its entirety.

### BACKGROUND

### 1. Field

The disclosure relates to an electronic device and method for correcting a typographical error in a keyboard input.

### 2. Description of Related Art

Along with the development of digital technology, electronic devices are provided in various forms such as a smartphone, a tablet personal computer (PC), or a personal digital assistant (PDA). Electronic devices are also being developed into forms wearable on users to improve portability and accessibility.

Upon execution of an application on a display, an electronic device may provide a virtual keyboard for a text input without connecting an external keyboard device. The virtual keyboard may be provided in various types depending on the form of the electronic device and the usability of a user.

The above information is presented as background information only to assist with an understanding of the disclosure. No determination has been made, and no assertion is made, as to whether any of the above might be applicable as prior art with regard to the disclosure.

### SUMMARY

An electronic device uses a keyboard (e.g., a virtual keyboard) displayed on a display, for input, and a typographical error may occur in a key input on the keyboard for various reasons. Conventionally, various techniques have been used to analyze the cause of a typographical error, and among them, analysis of an individual user typing touch trajectory is used. For example, depending on the user, there may be a repetitive pattern in which, when a specific key is input in a specific situation, a typographical error occurs by touching down exactly inside the key and then sliding and touching up outside the key.

Aspects of the disclosure are to address at least the above-mentioned problems and/or disadvantages and to provide at least the advantages described below. Accordingly, an aspect of the disclosure is to provide an electronic device and method for correcting a typographical error in a keyboard input, in which a correct key for a touch input is identified by considering various situations in which a typographical error occurs in the touch input, and input of the key is processed.

Additional aspects will be set forth in part in the description which follows and, in part, will be apparent from the description, or may be learned by practice of the presented embodiments.

In accordance with an aspect of the disclosure, an electronic device is provided. The electronic device includes a display including a touch screen, memory storing one or more computer programs, and one or more processors including processing circuitry communicatively coupled to the display and the memory, wherein the one or more computer programs include computer-executable instructions that, when executed by the one or more processors individually or collectively, cause the electronic device to control the display to display a keyboard in response to an application being executed, based on receiving a touch input from the keyboard, collect context data related to the touch input and store the collected context data in the memory, based on the collected context data, generate statistical data of a key being input and store the statistical data in the memory, based on the statistical data of the key being input and stored in the memory, analyze movement of the touch input and adjust a touch move sensitivity value based on a result of the analysis, based on the adjusted touch move sensitivity value, identify a key corresponding to a touch-down position or a touch-up position of the touch input as an input key, and process input of a character corresponding to the input key.

In accordance with another aspect of the disclosure, a method of operating an electronic device is provided. The method includes displaying a keyboard on a display of the electronic device in response to an application being executed, based on receiving a touch input from the keyboard, collecting context data related to the touch input and storing the collected context data in memory of the electronic device, based on the collected context data, generating statistical data of a key being input and storing the statistical data in the memory, based on the statistical data of the key being input, stored in the memory, analyzing movement of the touch input, and adjusting a touch move sensitivity value based on a result of the analysis, based on the adjusted touch move sensitivity value, identifying a key corresponding to a touch-down position or a touch-up position of the touch input as an input key, and processing input of a character corresponding to the input key.

In accordance with another aspect of the disclosure, one or more non-transitory computer-readable storage media storing one or more computer programs including computer-executable instructions that, when executed by one or more processors of an electronic device individually or collectively, cause the electronic device to perform operation are provided. The operations include displaying a keyboard on a display of the electronic device in response to an application being executed, based on receiving a touch input from the keyboard, collecting context data related to the touch input and storing the collected context data in memory of the electronic device, based on the collected context data, generating statistical data of a key being input and storing the statistical data in the memory, based on the statistical data of the key being input and stored in the memory, analyzing movement of the touch input and adjusting a touch move sensitivity value based on a result of the analysis, based on the adjusted touch move sensitivity value, identifying a key corresponding to a touch-down position or a touch-up position of the touch input as an input key, and processing input of a character corresponding to the input key.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a block diagram illustrating an electronic device in a network environment according to an embodiment of the disclosure;

FIG. 2 is a diagram illustrating an example of a keyboard in an electronic device according to an embodiment of the disclosure;

FIG. 3 is a diagram illustrating an example of typographical error correction in an electronic device according to an embodiment of the disclosure;

FIG. 4 is a diagram illustrating an example of typographical error correction in an electronic device according to an embodiment of the disclosure;

FIG. 5 is a diagram illustrating an example of typographical error correction in an electronic device according to an embodiment of the disclosure;

FIGS. 6A, 6B, 6C, 6D, and 6E are diagrams illustrating an example of typographical error correction in an electronic device according to various embodiments of the disclosure;

FIG. 7 is a diagram illustrating an example of typographical error correction in an electronic device according to an embodiment of the disclosure;

FIG. 8 is a diagram illustrating an example of a method of operating an electronic device according to an embodiment of the disclosure;

FIG. 9 is a diagram illustrating reconfiguration of a keyboard layout based on a deformation state of an electronic device according to an embodiment of the disclosure;

FIG. 10 is a diagram illustrating a deformation state of an electronic device according to an embodiment of the disclosure;

FIG. 11 is a diagram illustrating reconfiguration of a keyboard layout based on a deformation state of an electronic device according to an embodiment of the disclosure; and

FIG. 12 is a diagram illustrating reconfiguration of a keyboard layout based on a deformation state of an electronic device according to an embodiment of the disclosure.

Throughout the drawings, like reference numerals will be understood to refer to like parts, components, and structure.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

It should be appreciated that the blocks in each flowchart and combinations of the flowcharts may be performed by one or more computer programs which include instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g. a central processing unit (CPU)), a communication processor (CP, e.g., a modem), a graphics processing unit (GPU), a neural processing unit (NPU) (e.g., an artificial intelligence (AI) chip), a Wi-Fi chip, a Bluetooth® chip, a global positioning system (GPS) chip, a near field communication (NFC) chip, connectivity chips, a sensor controller, a touch controller, a finger-print sensor controller, a display driver integrated circuit (IC), an audio CODEC chip, a universal serial bus (USB) controller, a camera controller, an image processing IC, a microprocessor unit (MPU), a system on chip (SoC), an IC, or the like.

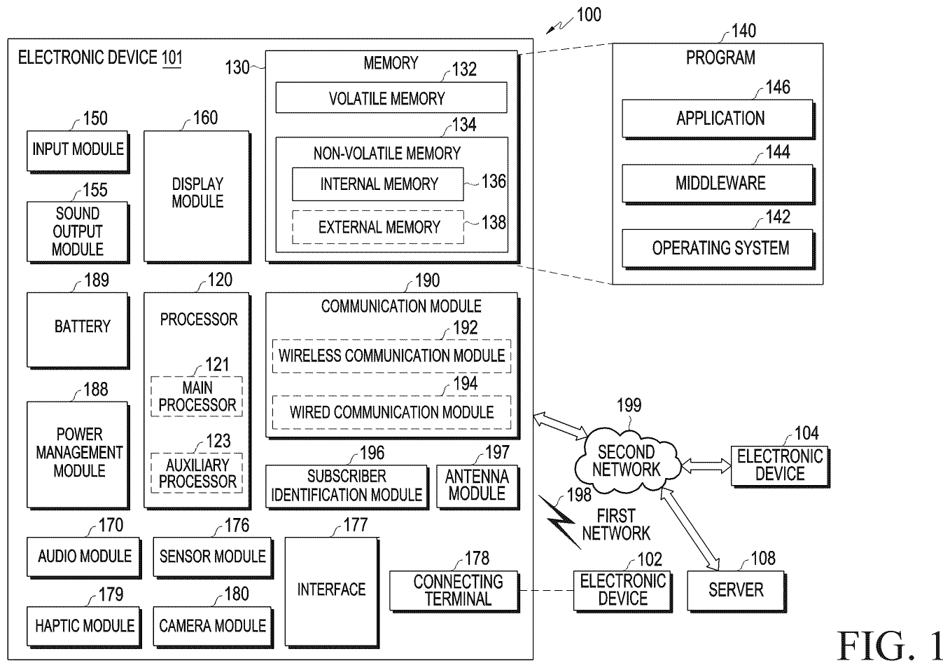

FIG. 1 is a block diagram illustrating an electronic device in a network environment according to an embodiment of the disclosure.

Referring to FIG. 1, the electronic device 101 in the network environment 100 may communicate with an electronic device 102 via a first network 198 (e.g., a short-range wireless communication network), or at least one of an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include a processor 120, memory 130, an input module 150, a sound output module 155, a display module 160, an audio module 170, a sensor module 176, an interface 177, a connecting terminal 178, a haptic module 179, a camera module 180, a power management module 188, a battery 189, a communication module 190, a subscriber identification module (SIM) 196, or an antenna module 197. In some embodiments, at least one of the components (e.g., the connecting terminal 178) may be omitted from the electronic device 101, or one or more other components may be added in the electronic device 101. In some embodiments, some of the components (e.g., the sensor module 176, the camera module 180, or the antenna module 197) may be implemented as a single component (e.g., the display module 160).

The processor 120 may execute, for example, software (e.g., a program 140) to control at least one other component (e.g., a hardware or software component) of the electronic device 101 coupled with the processor 120, and may perform various data processing or computation. According to an embodiment, as at least part of the data processing or computation, the processor 120 may store a command or data received from another component (e.g., the sensor module 176 or the communication module 190) in volatile memory 132, process the command or the data stored in the volatile memory 132, and store resulting data in non-volatile memory 134. According to an embodiment, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from, or in conjunction with, the main processor 121. For example, when the electronic device 101 includes the main processor 121 and the auxiliary processor 123, the auxiliary processor 123 may be adapted to consume less power than the main processor 121, or to be specific to a specified function. The auxiliary processor 123 may be implemented as separate from, or as part of the main processor 121.

The auxiliary processor 123 may control at least some of functions or states related to at least one component (e.g., the display module 160, the sensor module 176, or the communication module 190) among the components of the electronic device 101, instead of the main processor 121 while the main processor 121 is in an inactive (e.g., sleep) state, or together with the main processor 121 while the main processor 121 is in an active state (e.g., executing an application). According to an embodiment, the auxiliary processor 123 (e.g., an image signal processor or a communication processor) may be implemented as part of another component (e.g., the camera module 180 or the communication module 190) functionally related to the auxiliary processor 123. According to an embodiment, the auxiliary processor 123 (e.g., the neural processing unit) may include a hardware structure specified for artificial intelligence model processing. An artificial intelligence model may be generated by machine learning. Such learning may be performed, e.g., by the electronic device 101 where the artificial intelligence is performed or via a separate server (e.g., the server 108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134.

The program 140 may be stored in the memory 130 as software, and may include, for example, an operating system (OS) 142, middleware 144, or an application 146.

The input module 150 may receive a command or data to be used by another component (e.g., the processor 120) of the electronic device 101, from the outside (e.g., a user) of the electronic device 101. The input module 150 may include, for example, a microphone, a mouse, a keyboard, a key (e.g., a button), or a digital pen (e.g., a stylus pen).

The sound output module 155 may output sound signals to the outside of the electronic device 101. The sound output module 155 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 160 may visually provide information to the outside (e.g., a user) of the electronic device 101. The display module 160 may include, for example, a display, a hologram device, or a projector and control circuitry to control a corresponding one of the display, hologram device, and projector. According to an embodiment, the display module 160 may include a touch sensor adapted to detect a touch, or a pressure sensor adapted to measure the strength of force incurred by the touch.

The audio module 170 may convert a sound into an electrical signal and vice versa. According to an embodiment, the audio module 170 may obtain the sound via the input module 150, or output the sound via the sound output module 155 or a headphone of an external electronic device (e.g., an electronic device 102) directly (e.g., wiredly) or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to an embodiment, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., wiredly) or wirelessly. According to an embodiment, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the electronic device 102). According to an embodiment, the connecting terminal 178 may include, for example, a HDMI connector, a USB connector, a SD card connector, or an audio connector (e.g., a headphone connector).

The haptic module 179 may convert an electrical signal into a mechanical stimulus (e.g., a vibration or a movement) or electrical stimulus which may be recognized by a user via his tactile sensation or kinesthetic sensation. According to an embodiment, the haptic module 179 may include, for example, a motor, a piezoelectric element, or an electric stimulator.

The camera module 180 may capture a still image or moving images. According to an embodiment, the camera module 180 may include one or more lenses, image sensors, image signal processors, or flashes.

The power management module 188 may manage power supplied to the electronic device 101. According to an embodiment, the power management module 188 may be implemented as at least part of, for example, a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device via the first network 198 (e.g., a short-range communication network, such as Bluetooth™ wireless-fidelity (Wi-Fi) direct, or infrared data association (IrDA)) or the second network 199 (e.g., a long-range communication network, such as a legacy cellular network, a fifth-generation (5G) network, a next-generation communication network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 192 may identify and authenticate the electronic device 101 in a communication network, such as the first network 198 or the second network 199, using subscriber information (e.g., international mobile subscriber identity (IMSI)) stored in the subscriber identification module 196.

The wireless communication module 192 may support a 5G network, after a fourth-generation (4G) network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., the millimeter wave (mmWave) band) to achieve, e.g., a high data transmission rate. The wireless communication module 192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 192 may support various requirements specified in the electronic device 101, an external electronic device (e.g., the electronic device 104), or a network system (e.g., the second network 199). According to an embodiment, the wireless communication module 192 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of 1 ms or less) for implementing URLLC.

The antenna module 197 may transmit or receive a signal or power to or from the outside (e.g., the external electronic device) of the electronic device 101. According to an embodiment, the antenna module 197 may include an antenna including a radiating element composed of a conductive material or a conductive pattern formed in or on a substrate (e.g., a printed circuit board (PCB)). According to an embodiment, the antenna module 197 may include a plurality of antennas (e.g., array antennas). In such a case, at least one antenna appropriate for a communication scheme used in the communication network, such as the first network 198 or the second network 199, may be selected, for example, by the communication module 190 (e.g., the wireless communication module 192) from the plurality of antennas. The signal or the power may then be transmitted or received between the communication module 190 and the external electronic device via the selected at least one antenna. According to an embodiment, another component (e.g., a radio frequency integrated circuit (RFIC)) other than the radiating element may be additionally formed as part of the antenna module 197.

According to various embodiments, the antenna module 197 may form an mmWave antenna module. According to an embodiment, the mmWave antenna module may include a printed circuit board, a RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 101 and the external electronic device 104 via the server 108 coupled with the second network 199. Each of the electronic devices 102 or 104 may be a device of a same type as, or a different type, from the electronic device 101. According to an embodiment, all or some of operations to be executed at the electronic device 101 may be executed at one or more of the external electronic devices 102 or 104, or server 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, mobile edge computing (MEC), or client-server computing technology may be used, for example. The electronic device 101 may provide ultra low-latency services using, e.g., distributed computing or mobile edge computing. In another embodiment, the external electronic device 104 may include an internet-of-things (IoT) device. The server 108 may be an intelligent server using machine learning and/or a neural network. According to an embodiment, the external electronic device 104 or the server 108 may be included in the second network 199. The electronic device 101 may be applied to intelligent services (e.g., smart home, smart city, smart car, or healthcare) based on 5G communication technology or IoT-related technology.

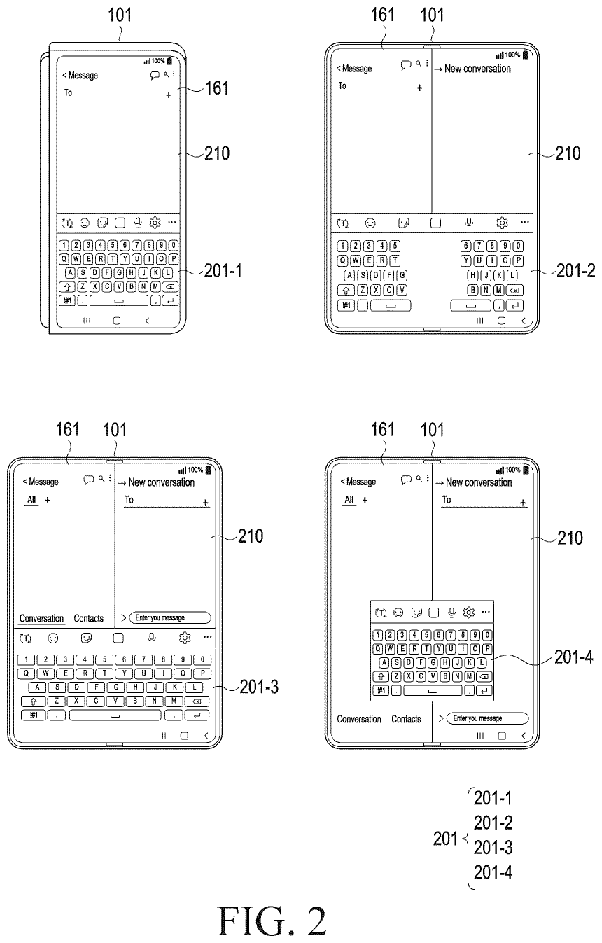

FIG. 2 is a diagram illustrating an example of a keyboard in an electronic device according to an embodiment of the disclosure.

Referring to FIGS. 1 and 2, the electronic device 101 (e.g., the electronic device 101 of FIG. 1) according to an embodiment may include the memory 130, the display module 160 including a display 161, and the at least one processor 120. In addition, the electronic device 101 according to an embodiment may further include the components included in FIG. 1.

According to an embodiment, the processor 120 of the electronic device 101 may execute an application (e.g., an application related to a messenger, a message, a memo, a call, text writing, or text editing, or various applications requiring text input) for displaying a keyboard 201 (e.g., a virtual keyboard). An execution screen 210 may be displayed on the display 161 (e.g., the display module 160 of FIG. 1). Upon user request for keyboard execution, the processor 120 may execute the keyboard 201 (e.g., a virtual keyboard) and display the keyboard 201 on the display 161. The processor 120 may display the keyboard 201 with or without overlap in a portion of the execution screen 210. When executing the keyboard 201, the processor 120 may dispose keys by setting a position value (e.g., coordinates) for each of the keys included in the keyboard 201 in a portion of the display 161 where the keyboard 201 is displayed. As illustrated in FIG. 2, the keyboard 201 may include various types of keyboards (e.g., a QWERTY keyboard 201-1 in a folded state, a split keyboard 201-2, a QWERTY keyboard 201-3 in an unfolded state, a floating keyboard 201-4, a numeric keyboard, or other various types of keyboards) having different sizes or shapes of keyboard layouts, based on the shape (e.g., form factor) of a housing of the electronic device 101 or a change (e.g., folding or rolling) of the housing. The keyboard 201 may include various keys, such as language keys (e.g., letters, numbers, and/or symbols) and non-language keys (e.g., a Space key, a Delete key, an Enter key, a Shift key, a Korean/English key, Direction keys, and/or other command keys). When the size of the display changes due to deformation of a portion of the housing of the electronic device 101 by folding, unfolding, sliding, or rolling, the processor 120 may reconfigure the layout of the currently displayed keyboard (e.g., change to a different keyboard or change the size of the keyboard).

According to an embodiment, the processor 120 may receive a touch input as an input event from the keyboard displayed on the display 161. For example, the processor 120 may detect a position (e.g., a coordinate value on a touch screen) touched by a user's hand or an external input device such as an electronic pen through the touch screen of the display 161. The processor 120 may identify the position (e.g., a touch-down position and a touch-up position) of the touch input through the detected coordinate value of the touch screen. The touch input may be an input of a key other than a user-intended key depending on a user, a user situation, or a keyboard type. According to an embodiment, the processor 120 may collect context data for the touch input in response to the reception of the touch input, generate statistical data by analyzing the touch-down position and the touch-up position of the touch input based on the collected context data, identify a correct input key for the touch input based on the statistical data, and perform input processing, so that a typographical error due to a key other than the user-intended key may be corrected. For example, when a specific key is input by the user, a touch-up may be accurate, and when another specific key is input, a touch-down may be accurate. Since the touch-down and touch-up of a touch input may differ depending on users, key types, and/or situations, the processor 120 may generate statistical data by analyzing the movement of the touch input for each user, keyboard type, and/or state of a current usage environment of the electronic device.

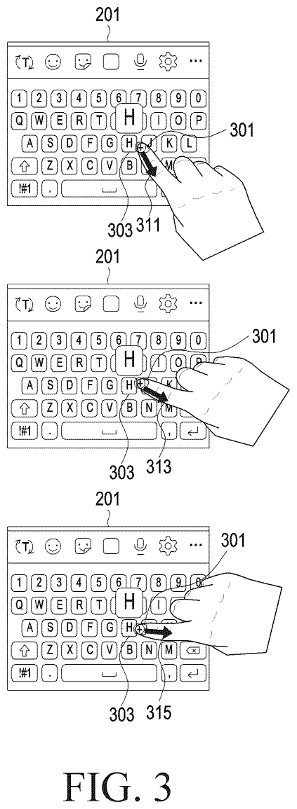

FIG. 3 is a diagram illustrating an example of correcting a typographical error in an electronic device according to an embodiment of the disclosure.

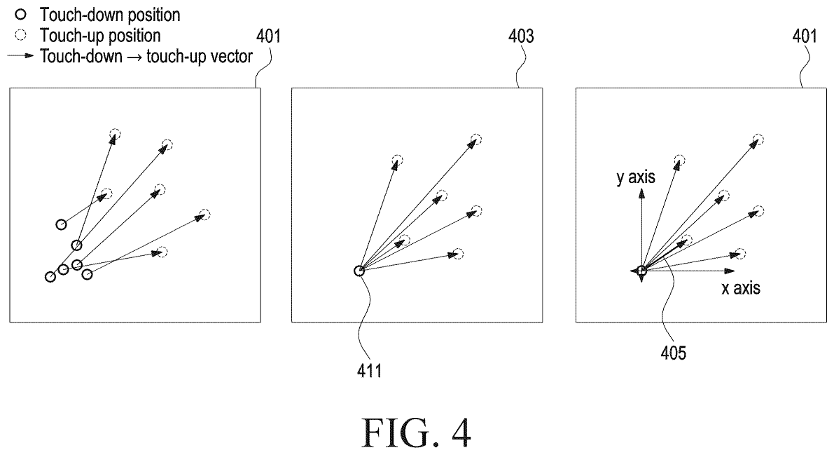

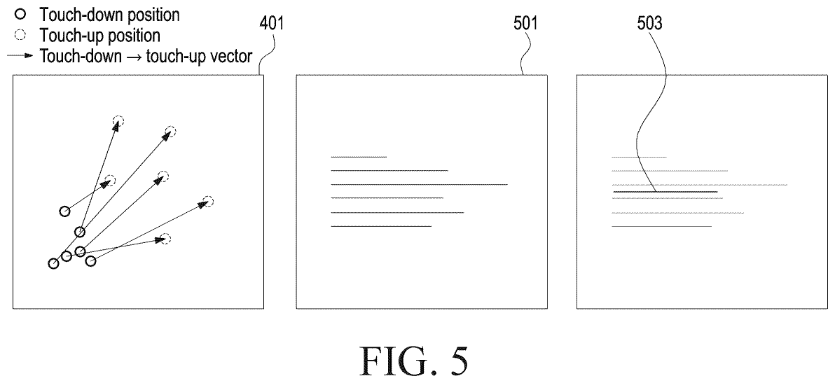

FIGS. 4 and 5 are diagrams illustrating an example of correcting a typographical error in an electronic device according to various embodiments of the disclosure.

Referring to FIGS. 1, 2, 3, 4, and 5, according to an embodiment, upon receipt of a user touch input 301 through the touch screen of the display 161, the processor 120 may identify a key 303 (e.g., “H”), which is being input, corresponding to a position where the touch input 301 is detected. In response to the touch input 301, the processor 120 may perform an operation of collecting context data for the key 303 which is being input. The processor 120 may collect and store (or update) the context data for a specified time period or continuously. The collected context data for the key 303 which is being input may be stored as a touch data record in a specified first database included in the memory 130. The first database may store context data for each key included in the keyboard 201 by classifying by user, keyboard type, and/or state of the electronic device. The context data may include at least one of a keyboard type, the coordinates of a touch input, a touch-down position pDown, a touch-up position pUp, a touch duration pDuaration, an entered key keyinput, collected profiling data (e.g., information collected using an artificial intelligence (AI) function, time, place, and occasion, and/or a user behavior pattern), environmental information about a current situation (e.g., physical information including sensor values such as a folded or unfolded state and an inclination of the electronic device, and contextual information), or grip information (e.g., one-hand grip, two-hand grip, right-hand grip, or left-hand grip). For example, in response to the touch input 301, the electronic device may identify a touch-down position and/or a touch-up position and a touch duration based on the position of the touch input 301 detected through the touch screen, collect the identified touch-down position and/or the touch-up position and the touch duration as context data, and store (or update) the context data in the first database included in the memory 130. For example, the processor 120 may identify the keyboard type of the displayed keyboard 201, identify a user's gripping style using at least one sensor (e.g., the sensor module 176 of FIG. 1), collect information about the identified keyboard type and gripping style as context data, and store or update the context data in the first database. For example, since the input key according to the touch input may be different for each user or in each usage environment, the processor 120 may identify the user, collect status information and profile data according to the current usage environment of the user's electronic device, and store (or update) the collected status information and profile data as context data in the first database.

According to an embodiment, the processor 120 may generate statistical data corresponding to the position of the touch input 301 based on the collected context data, and store the generated statistical data in a second database of the memory 130. According to an embodiment, the processor 120 may analyze movement information (e.g., a direction or distance based on movement) at the touch input position (e.g., the touch-down position and/or the touch-up position) of the touch input 301 based on the collected context data. According to an embodiment, the processor 120 may obtain a vector (or vector value) 311, 313, or 315 representing a direction and distance from the touch-down position to the touch-up position of the key 303 which is being input, and store the obtained vector as statistical data in the second database included in the memory. According to an embodiment, the electronic device may obtain a scalar (or scalar value) representing the distance from the touch-down position to the touch-up position of the key which is being input, and store the obtained scalar as statistical data in the second database included in the memory. For example, as illustrated in FIG. 3, the processor 120 may have the vector (or vector value) 311, 313, or 315 for the touch input 301 in a different direction according to a user input pattern. According to an embodiment, the processor 120 may generate a key set (e.g., a tuple set) based on context information obtained from a touch database according to touch input coordinates, identify whether the tuple set is an empty set, and when the tuple set is an empty set, generate statistical data, and when the tuple set is not an empty set, select another key other than the tuple set, and perform a removal operation on the tuple set. The processor 120 may obtain a touch input data collection from the first database in response to the selected tuple, and when the number of touch input data collections is less than a specific number, perform the operation repeatedly until the tuple set is an empty set. When the number of touch input data collections is equal to or greater than the specific number, the processor 120 may perform an operation of generating statistical data for the corresponding key, using the data collections. The generated statistical data may be stored in a statistical database on a key basis, and an operation of adjusting a touch move sensitivity value based on the statistical data stored on a key basis may be performed.

According to an embodiment, the processor 120 may collect touch motion vectors and scalars based on touch-down positions and touch-up positions of the corresponding input key by repeatedly performing the operation of obtaining the touch motion vector 311, 313, or 315 and a scalar movement distance 501 whenever a touch input 301 of the input key is detected. The collection of vectors and scalars of touch movements for the key 303 which is being input, illustrated in FIG. 3 has been described as an example for convenience of description, to which the disclosure is not limited, and the processor 120 may collect touch motion vectors and scalars for other keys included in the keyboard 201 in the same manner.

According to an embodiment, the processor 120 may obtain statistical data from the second database based on the position of the touch input, and analyze a direction-based movement of the touch input 301 based on the obtained statistical data. According to an embodiment, as illustrated in FIG. 4, the processor 120 may obtain collected vector values based on the statistical data, and obtain an average vector value by averaging the obtained vector values. According to an embodiment, as illustrated in FIG. 5, the processor 120 may obtain collected scalar values based on the statistical data, and obtain an average scalar value by averaging the obtained scalar values.

Referring to FIG. 4, the processor 120 may obtain aligned touch motion vectors 403 by aligning collected touch motion vectors 401 based on a reference touch-down position 411, and obtain an average vector 405 (or an average vector value) based on the aligned touch motion vectors 403. According to an embodiment, as illustrated in FIG. 5, the processor 120 may obtain scalar movement distances 501 of the touch trajectories of the collected touch motion vectors 401, and obtain an average scalar 503 (or an average scalar value) based on the scalar movement distances 501 of the touch trajectories. The distance of a scalar is different from the distance of a vector in that the distances of vectors in opposite directions are offset, and the distances of scalars even in opposite directions are not offset.

According to an embodiment, the processor 120 may adjust the touch move sensitivity value for the touch input based on a result of analyzing the direction-based movement for the touch input. The processor 120 may adjust the touch move sensitivity value for the input key to reduce a typographical error based on the average vector 405 and the average scalar 503 obtained through the method of FIGS. 4 and 5.

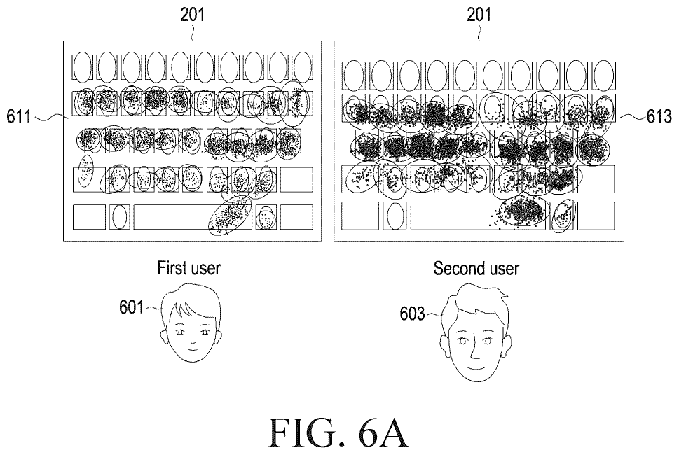

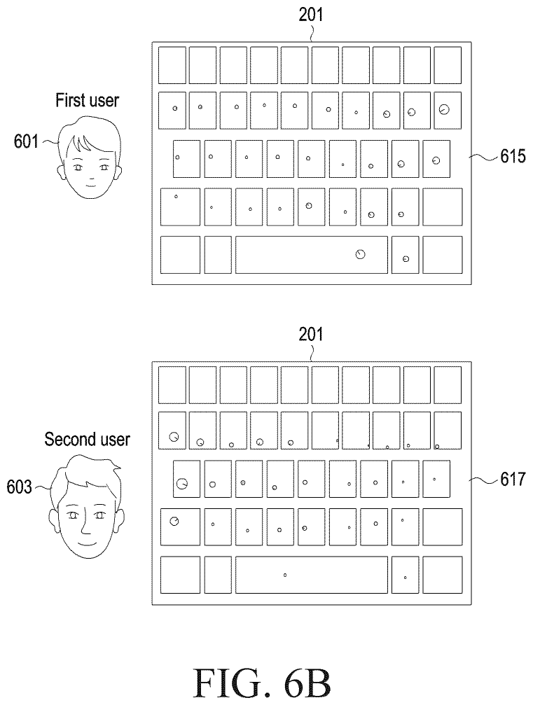

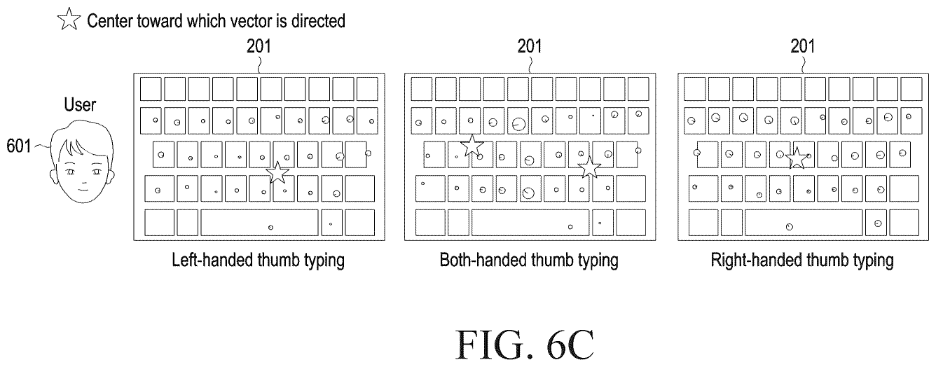

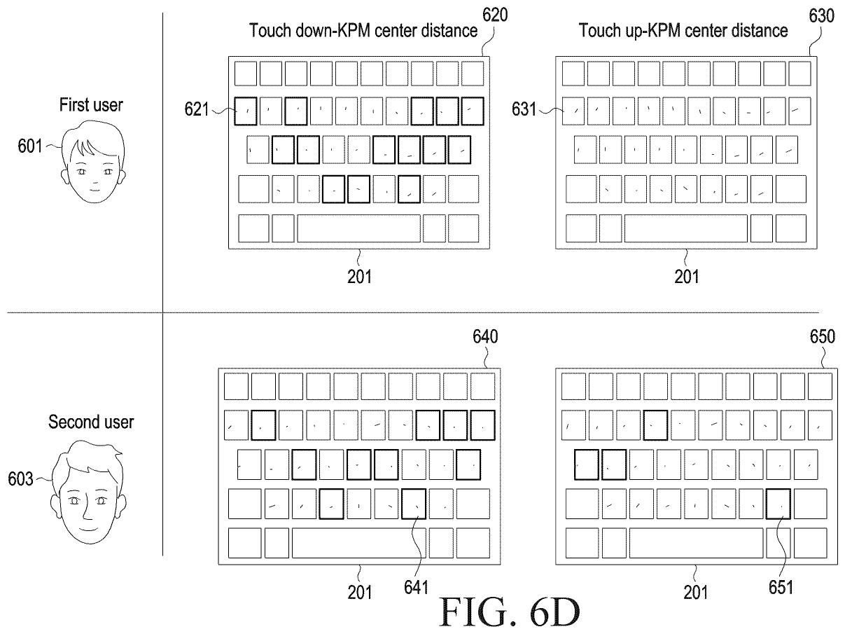

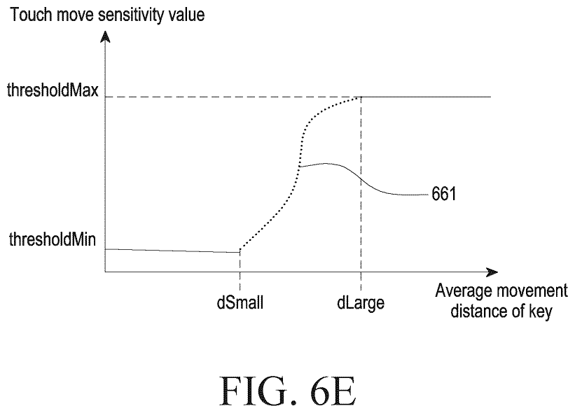

FIGS. 6A, 6B, 6C, 6D, and 6E are diagrams illustrating an example of correcting a typographical error in an electronic device according to various embodiments of the disclosure.

Referring to FIG. 6A, according to an embodiment, the processor 120 may obtain statistical data from the memory 130 and analyze a touch trajectory for each key input of the keyboard 201 based on the obtained statistical data. The processor 120 may analyze an input density of each key (e.g., a density model 611 for a first user 601 and a density model 613 for a second user 603 in FIG. 6A) by analyzing the statistical data on a user basis (e.g., the first user 601 and the second user 603). According to an embodiment, the processor 120 may analyze a two-dimensional Gaussian distribution confidence interval of touch up/touch-down positions for each key. The processor 120 may identify a more accurate position of the touch-down position and the touch-up position for each key by determining a degree to which the distribution of confidence intervals of the touch-up/touch-down position for each key input matches a specified key press model of the keyboard 201. The specified key press model is used to analyze a key input density, and may include touch data including at least one of key identification information (e.g., the name of a key), a first length, major (a major axis length of an ellipse), a second length, minor (a minor axis length of the ellipse), a ratio of the first length or the second length, eccen (the closer to 1, the closer to a circle), an area of the ellipse, ell (ipse) area, a symbol for the area of the ellipse, comp (e.g., >, =, <), or the area of the key, key area. According to an embodiment, the processor 120 may analyze a match degree by comparing the confidence interval distribution of a key being input (e.g., the key 303 of FIG. 3) for a touch input with a key press model. Based on a result of the analysis of the match degree, the processor 120 may identify which position of the touch-down position and the touch-up position of the key which is being input is more accurate. According to an embodiment, the processor 120 may compare at least one of the touch-down position or touch down up position of the touch input with the center of the key press model, and when the touch-down position is identified as closer to the center of the key press model, identify the touch-down position as a more accurate position (e.g., identify that accuracy of the touch-down position is greater than accuracy of the touch-up position). According to an embodiment, the processor 120 may compare at least one of the touch-down position or touch down up position of the touch input with the center of the key press model, and when the touch-up position is identified as closer to the center of the key press model, identify the touch-up position as a more accurate position (e.g., identify that the accuracy of the touch-up position is greater than the accuracy of the touch-down position). The accurate position for the touch input may be identified differently depending on a key input density collected differently by user (e.g., a user's keyboard usage pattern), by state (e.g., a form factor and a folded or unfolded state) according to the current usage environment of the electronic device, or by gripping style (e.g., one-hand grip by the left or right hand or two-hand grip). The processor 120 may identify a more accurate position for a touch input based on user information, status information according to the current usage environment of the electronic device, and gripping style information.

Referring to FIG. 6B, according to an embodiment, the processor 120 may analyze a vector and/or a scalar by analyzing the distance from a touch-down position to a touch-up position. The processor 120 may represent an average vector (e.g., a circle displayed within each key) and/or an average scalar (e.g., a line displayed within the circle) of each key (e.g., a square within the keyboard) of the keyboard 201, using vector and scalar models 615 and 617 of the keyboard 201 for the users 601 and 603, respectively. As illustrated in FIG. 6B, the average vector of each key may be represented as a circle whose radius is the average (e.g., scalar average) of movement distances from touch-down to touch-up, centered on an average point of touch-down positions. As illustrated in FIG. 6B, the average scalar of each key may be represented as a line (e.g., a line displayed within a circle) representing the average of touch-down to touch-up vectors starting from the average point of touch-down coordinates. The processor 120 may identify that as a circle is larger, a moved distance is longer after touching, and as the radius of a circle and the length of a line are more approximate, a bias direction is more constant (e.g., |vector|≤scalar).

Referring to FIG. 6C, the processor 120 may analyze a direction in which vectors gather (e.g., a center 631 toward which the vectors are directed) according to a grip state, for example, based on collected context data for the second user. For example, the processor 120 may identify that when the second user types in a two-hand grip state, a key pressed with the left hand moves toward, for example, the “└” and “o” keys, and a key pressed with the right hand moves toward, for example, the “┤” and “├” keys. For example, based on the collected context data for the second user, the processor 120 may identify that when the second user types with one hand, the second user tends to move toward a point at the center of the keyboard, for example, toward the “ [symbol] ” or “⊥” key, regardless of the type of the hand. The processor 120 may determine the one-hand or two-hand grip state and the degree of a touch movement of a specific key, according to whether directions in which the vectors of keys mainly typed with the left hand and the vectors of keys mainly typed with the right hand are directed (e.g., whether the centers 631 to which the vectors are directed) coincide with each other, based on the result (e.g., keyboard typing layouts of FIG. 6C) of the analysis of the directions in which the vectors are gathered according to the grip states.

Referring to FIG. 6D, according to an embodiment, the processor 120 may use a Gaussian distribution model of touch inputs for inputting each key, obtained based on statistical data. The Gaussian distribution model as illustrated in FIG. 6D may represent a distribution of positions estimated to be input by the user to input a corresponding key, which has been learned by the keyboard from the user's touch inputs, and may be a distribution using the center point of each key as an average, and having a fixed variance value. In FIG. 6D, user-specific Gaussian distribution models 620 and 630 may represent the distance between a touch-down point used to input each key and the center point of a specified key press model, and user-specific Gaussian distribution models 640 and 650 may represent the distance between a touch-up point used to input each key and the center point of the specified key press model. The processor 120 may identify which position is closer to the center of the key press model by comparing the distance between the touch-down position or the touch-up position and the center point of the key press model based on the collected data using the obtained average vector value or average scalar value, and identify the closer position as a correct position. For example, for the first user 601, the Gaussian distribution model 620 may have many keys (e.g., keys indicated by bold lines among the keys of the keyboard) with touch-down positions closer to the center point of the key press model, and the Gaussian distribution model 630 may not have keys with touch-up positions closer to the center point of the key press model. For the first user 601, as the processor 120 identifies a touch-down position for a key 621 which is being input as closer to the center point of the key press model in the Gaussian distribution model, it may identify the touch-down position as more correct for the key 621. For example, for the second user 603, the Gaussian distribution model 640 may have many keys (e.g., keys indicated by bold lines among the keys of the keyboard) with touch-down positions closer to the center point of the key press model, and the Gaussian distribution model 650 may have fewer keys with touch-up positions closer to the center point of the key press model than the Gaussian distribution model 640. For the second user 603, as the processor 120 identifies that a key 641 being input has a touch-down position closer to the center point of the key press model in the Gaussian distribution model 640, it may identify the touch-down position for the key 641 being input as more accurate, and as the processor 120 identifies that another key 651 being input has a touch-up position closer to the center point of the key press model in the Gaussian distribution model 650, it may identify the touch-down position for the key 651 being input as more accurate.

Referring to FIG. 6E, according to an embodiment, the processor 120 may adjust a touch move sensitivity value based on statistical data generated based on an analyzed average vector and average scalar. Upon receipt of a user touch input for a key input, the processor 120 may obtain information about an average scalar and the distance between the center of a key press model and an average touch-down value based on statistical data. The processor 120 may adjust the touch move sensitivity value in response to the average scalar. According to an embodiment, the processor 120 may adjust the touch move sensitivity value to a high value equal to or greater than a specified first threshold, thresholdMax, based on identifying that the distance between the center of the key press model and the average touch-down value is more accurate, when the scalar value of the current touch input is equal to or greater than a second distance value dLarge. The processor 120 may set the touch move sensitivity value to a default value, based on identifying that the distance between the center of the key press model and the average touch-down value is not accurate.

According to an embodiment, when the scalar value of the current touch input is equal to or less than a specified first distance value dSmall, the processor 120 may set the touch move sensitivity value to a low value equal to or less than a specified second threshold, thresholdMin. When the scalar value of the currently input key is a value between the first distance value dSmall and the second distance value dLarge, the processor 120 may set the touch move sensitivity value to an interpolated value 661 between the first threshold and the second threshold. The interpolated value 661 may be obtained through an interpolation method of experimentally selecting and using a monotonically increasing function.

According to an embodiment, when the movement distance (e.g., average vector value or average scalar value) of the touch input for the currently input key is less than the touch move sensitivity value, the processor 120 may ignore movement after the touch-down and process a key at the touch-down position as an input key, considering that the touch is maintained at the touch-down position.

According to an embodiment, when the movement distance of the user touch which is being input is greater than the touch move sensitivity value, the processor 120 may process a key at a position (e.g., a touch-up position) where the current touch is in progress as an input key.

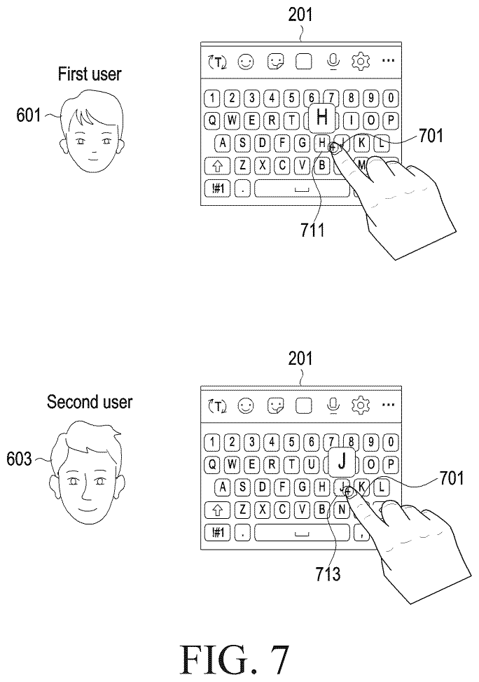

FIG. 7 is a diagram illustrating an example of correcting a typographical error in an electronic device according to an embodiment of the disclosure.

Referring to FIG. 7, according to an embodiment, the processor 120 may display an input key identified through adjustment of a touch move sensitivity value on a portion of a touch input area of a keyboard displayed on the display 161. The input key displayed on the display 161 may be displayed differently by adjusting the touch move sensitivity value even when different users make touch inputs at the same position. For example, when the first user 601 touches down on a key 711 (e.g., the H key) being input and touches up to, for example, the position of the B key in response to a touch input 701, the first user 601 may identify the touch-down position as more accurate and process the key 711 being input (e.g., the H key) as an input key, and display a character (e.g., “H”) indicated by the input key on a partial area of the keyboard 201. For example, when the second user 603 touches down on the key 711 being input (e.g., the H key) and touches up, for example, on the position of the B key in response to the touch input 701, the second user 603 may identify the touch-up position as more accurate, ignore the key 711 being input, process a key 713 (e.g., the J key) corresponding to the touch-up position as an input key, and display a character (e.g., “J”) indicated by the input key in a partial area of the keyboard 201.

Referring to FIGS. 1 and 2, the electronic device 101 according to an embodiment may implement a software module (e.g., the program 140 of FIG. 1) for executing a typographical error correction application. The memory 130 of the electronic device 101 may store instructions to implement the software module for displaying the keyboard 201 illustrated in FIG. 2. At least one processor 120 may execute the instructions stored in the memory 130 to implement the software module for displaying the keyboard 201 illustrated in FIG. 2, and control hardware (e.g., the sensor module 176, the display module 160, or the communication module 190 of FIG. 1) associated with the function of the software module for displaying the keyboard 201. The software module of the electronic device 101 according to an embodiment may be configured to include a kernel (or HAL), a framework (e.g., the middleware 144 of FIG. 1), and an application (e.g., the application 146 of FIG. 1). At least a portion of the software module may be preloaded on the electronic device 101 or downloadable from a server (e.g., the server 108).

In an embodiment, the main components of an electronic device have been described above in the context of the electronic device 101 of FIGS. 1 and 2. However, in various embodiments, all of the components illustrated in FIGS. 1 and 2 are not essential components, and the electronic device 101 may be implemented with more or fewer components than the illustrated components. In addition, the positions of the main components of the electronic device 101 described above with reference to FIGS. 1 and 2 may be changed according to various embodiments.

According to an embodiment, an electronic device (e.g., the electronic device 101 of FIGS. 1 and 2) may include the display 161, the memory 130 storing instructions, and at least one processor 120 including processing circuitry.

According to an embodiment, the instructions, when executed by the at least one processor individually or collectively, may cause the electronic device to control the display to display the keyboard 201 in response to an application being executed.

According to an embodiment, the instructions, when executed by the at least one processor individually or collectively, may cause the electronic device to, based on receiving a touch input from the keyboard, collect context data related to the touch input and store the collected context data in the memory.

According to an embodiment, the instructions, when executed by the at least one processor individually or collectively, may cause the electronic device to, based on the collected context data, generate statistical data of a key being input and store the statistical data in the memory.

According to an embodiment, the instructions, when executed by the at least one processor individually or collectively, may cause the electronic device to, based on the statistical data of the key being input, stored in the memory, analyze movement of the touch input, and adjust a touch move sensitivity value based on a result of the analysis.

According to an embodiment, the instructions, when executed by the at least one processor individually or collectively, may cause the electronic device to, based on the adjusted touch move sensitivity value, identify a key corresponding to a touch-down position or a touch-up position of the touch input as an input key.

According to an embodiment, the instructions, when executed by the at least one processor individually or collectively, may cause the electronic device to process input of a character corresponding to the input key.

According to an embodiment, the instructions, when executed by the at least one processor individually or collectively, may cause the electronic device to control the display to display the character corresponding to the input key in a partial of the keyboard.

According to an embodiment, the instructions, when executed by the at least one processor individually or collectively, may cause the electronic device to obtain the touch-down position, the touch-up position, and a touch duration of the touch input, and collect the touch-down position, the touch-up position, and the touch duration of the touch input as the context data.

According to an embodiment, the instructions, when executed by the at least one processor individually or collectively, may cause the electronic device to, based on a size change of the display in response to shape deformation of a housing of the electronic device, control the display to reconfigure and display a layout of the keyboard, identify a type of the keyboard displayed on the display, identify a user's gripping style using at least one sensor of the electronic device, and collect status information based on the shape deformation of the housing, the type of the keyboard, and the gripping style as the context data.

According to an embodiment, the instructions, when executed by the at least one processor individually or collectively, may cause the electronic device to generate a key set based on the collected context data, obtain a touch input collection corresponding to the key set, and generate the statistical data based on the touch input collection.

According to an embodiment, the instructions, when executed by the at least one processor individually or collectively, may cause the electronic device to, based on receiving the touch input, identify the touch-down position and the touch-up position of the key being input, stored in the memory, obtain a vector representing a touch movement direction and a touch movement distance from the touch-down position to the touch-up position, obtain a scalar representing the touch movement distance from the touch-down position to the touch-up position, generate statistical data based on at least one of the vector or the scalar for the key being input, and store the generated statistical data in the memory.

According to an embodiment, the instructions, when executed by the at least one processor individually or collectively, may cause the electronic device to compare at least one of the touch-down position or the touch-down-up position of the key being input with a center of a key press model, based on identifying that the touch-down position is closer to the center of the key press model, identify that accuracy of the touch-down position is greater than accuracy of the touch-up position, and based on identifying that the touch-up position is closer to the center of the key press model, identify that the accuracy of the touch-up position is greater than the accuracy of the touch-down position.

According to an embodiment, the instructions, when executed by the at least one processor individually or collectively, may cause the electronic device to obtain the statistical data for the key being input from the memory, based on the statistical data, obtain collected vector values for the key being input and obtain an average vector value of the collected vector values, based on the statistical data, obtain collected scalar values for the key being input and obtain an average scalar value of the collected scalar values, and based on the average vector value or the average scalar value, adjust the touch move sensitivity value.

According to an embodiment, the instructions, when executed by the at least one processor individually or collectively, may cause the electronic device to, when the average scalar value of the key being input for the touch input is equal to or greater than a first threshold distance, identify that accuracy of the touch-down position is greater than accuracy of the touch-up position based on the touch-down position being closer to the center of the specified key press model and adjust the touch move sensitivity value to be equal to or greater than the first threshold distance, when the average scalar value of the key being input for the touch input is equal to or less than a second threshold distance, adjust the touch move sensitivity value to be equal to or less than the second threshold distance, and when the average scalar value of the key being input for the touch input is between the first threshold distance and the second threshold distance, adjust the touch move sensitivity value to an interpolated value between the first threshold distance and the second threshold distance.

According to an embodiment, the instructions, when executed by the at least one processor individually or collectively, may cause the electronic device to, when a touch movement distance of the key being input is less than a touch move sensitivity value set as a default value, ignore movement after a touch-down, identify a key corresponding to the touch-down position as the input key, and process input of the key, and when the touch movement distance of the key corresponding to the position of the touch input is equal to or greater than the touch move sensitivity value set as the default value, identify a key at the touch-up position, which is a position where the touch input is performed, as the input key, and process input of the key.

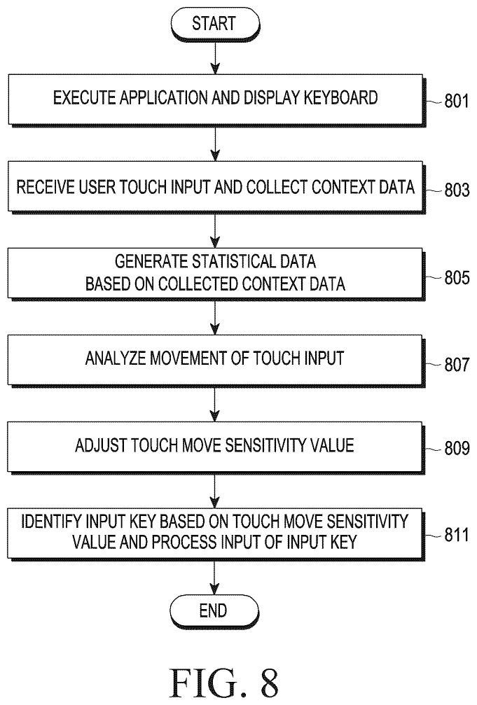

FIG. 8 is a diagram illustrating an example of a method of operating an electronic device according to an embodiment of the disclosure.

Referring to FIG. 8, in operation 801, the electronic device (e.g., the electronic device 101 of FIGS. 1 and 2) according to an embodiment may execute an application (e.g., an application related to a messenger, a message, a memo, a call, text writing, or text editing, or various applications requiring text input) and display a keyboard (e.g., a virtual keyboard) in an area of an execution screen of the application displayed on a display (e.g., the display module 160 of FIG. 1 and the display 161 of FIG. 2). The keyboard may include various types of keyboards (e.g., the QWERTY keyboard 201-1 in the folded state, the split keyboard 201-2, the QWERTY keyboard 201-3 in the unfolded state, the floating keyboard 201-4, a numeric keyboard, or other types of keyboards having different sizes or shapes of keyboard layouts) based on the shape (e.g., form factor) of a housing of the electronic device 101 or a change (e.g., folding or rolling) of the housing. The keyboard 201 may include various keys, such as language keys (e.g., letters, numbers, and/or symbols) and non-language keys (e.g., a Space key, a Delete key, an Enter key, a Shift key, a Korean/English key, Direction keys, and/or other command keys).

In operation 803, the electronic device may perform an operation of receiving a touch input as an input event in the area of the display 161 on which the keyboard 201 is displayed, for input of at least one key included in the keyboard 201, and collecting context data in response to the touch input. According to an embodiment, the electronic device may detect a position (e.g., a coordinate value) of a touch screen touched by a user's hand or an external input device such as an electronic pen through the touch screen of the display 160, and identify the position of the touch input through the detected coordinate value of the touch screen. According to an embodiment, the electronic device may identify a position where the touch input is started as a touch-down position, and identify a position where the touch input is completed as a touch-up position. The electronic device may identify a key included in the keyboard 201 corresponding to the touch-down position as a key which is being input.

According to an embodiment, when the electronic device performs the operation of collecting context data, it may collect and store (or update) the context data for a specified time period or continuously. The context data may include at least one of a keyboard type, the coordinates of a touch input, a touch-down position pDown, a touch-up position pUp, a touch duration pDuaration, an entered key keyinput, collected profiling data (e.g., information collected using an AI function, time, place, and occasion, and/or a user behavior pattern), environmental information about a current situation (e.g., physical information including sensor values such as a folded or unfolded state and an inclination of the electronic device, and contextual information), or grip information (e.g., one-hand grip, two-hand grip, right-hand grip, or left-hand grip). The collected context data may be stored as a touch data record in a specified first database included in the memory 130. For example, in response to the touch input, the electronic device may identify a touch-down position and/or a touch-up position and a touch duration based on the position of the touch input detected through the touch screen, collect the identified touch-down position and/or touch-up position and touch duration as context data, and store (or update) the context data in the first database included in the memory 130. For example, the electronic device may identify the keyboard type of the displayed keyboard 201, identify a user's gripping style using at least one sensor, collect information about the identified keyboard type and gripping style as context data, and store (or update) the context data in the first database. For example, since the input key according to the touch input may be different for each user or in each usage environment, the electronic device may identify the user, collect status information and profile data according to the current usage environment of the user's electronic device, and store (or update) the collected status information and profile data as context data in the first database.

In operation 805, the electronic device may generate statistical data corresponding to the position of the touch input based on the collected context data, and store the generated statistical data in the memory. According to an embodiment, the electronic device may analyze movement information (e.g., direction or distance) according to movement of the touch input position (e.g., touch-down position and/or touch-up position) of the touch input based on the collected context data. According to an embodiment, the electronic device may obtain a vector (or vector value) representing the direction and distance from the touch-down position to the touch-up position of the key being input, and store the obtained vector as statistical data in a second database included in the memory. According to an embodiment, the electronic device may obtain a scalar (or scalar value) representing the distance from the touch-down position to the touch-up position of the key being input, and store the obtained scalar as statistical data in the second database included in the memory.

In operation 807, the electronic device may obtain statistical data from the second database based on the touch input position, and analyze a direction-based movement of the touch input based on the obtained statistical data. According to an embodiment, the electronic device may obtain collected vector values based on the statistical data, and obtain an average vector value by averaging the obtained vector values. The electronic device may obtain collected scalar values based on the statistical data, and obtain an average scalar value by averaging the obtained scalar values. According to an embodiment, the electronic device may analyze a two-dimensional Gaussian confidence interval distribution of touch-down positions and/or touch-up positions based on a key input density based on the statistical data, and identify a match degree by comparing the confidence interval distribution with a specified key press model. The electronic device may identify a more accurate position of the touch-down position and the touch-up position, based on the match degree of the key being input, which is identified by comparing the confidence interval distribution with the key press model. According to an embodiment, the electronic device may compare at least one of the touch-down position or the touch-down-up position of the touch input with the center of the key press model, and when the touch-down position is identified as closer to the center of the key press model, identify the touch-down position as a more accurate position. According to an embodiment, the electronic device may compare at least one of the touch-down position or the touch-down-up position of the touch input with the center of the key press model, and when the touch-up position is identified as closer to the center of the key press model, identify the touch-up position as more accurate. The accurate position of the touch input may be identified differently, because the key input density is collected differently depending on users (e.g., a user's keyboard usage pattern), states (e.g., a form factor and a folded or unfolded state) according to the current usage environment of the electronic device, or gripping styles (e.g., one-hand grip by the left or right hand or two-hand grip). The electronic device may identify a more accurate position for the touch input based on user information, status information according to the current usage environment of the electronic device, and gripping style information.

In operation 809, the electronic device may adjust a touch move sensitivity value for the touch input, based on a result of analyzing a direction-based movement of the touch input. According to an embodiment, the electronic device may adjust the touch move sensitivity value using the key press model based on the result of identifying a more accurate position of the touch-down position and the touch-up position, and the average vector value or the average scalar value. According to an embodiment, when the average scalar value of the key being input is equal to or greater than a first threshold distance, the electronic device may compare the center of the key press model with the average vector value or the average scalar value, and when the touch-down position is identified as more accurate than the touch-up position, identify it as closer to the center of the key press model and adjust the touch move sensitivity value to a first threshold (e.g., a highest value) or greater. When the touch down is not more accurate, the electronic device may set the touch move sensitivity value to a default value. According to an embodiment, when the average scalar value of the key being input is equal to or less than a second threshold distance, the electronic device may adjust the touch move sensitivity value to the second threshold (e.g., a lowest value) or less. The second threshold may be smaller than the first threshold. According to an embodiment, when the average scalar value of the key being input is a value between the first threshold distance and the second threshold distance, the electronic device may adjust the touch move sensitivity value to an interpolated value between the first threshold and the second threshold.

In operation 811, the electronic device may identify an input key corresponding to the touch input position on the keyboard based on the adjusted touch move sensitivity value, process input of the identified input key, and display a character indicated by the input key in an area of the keyboard displayed on the display. According to an embodiment, when a touch movement distance of the key being input is less than the touch move sensitivity value set to the default value, the electronic device may ignore movement after the touch down, identify a key corresponding to the touch-down position as the input key, and process input of the key. According to an embodiment, when the touch movement distance of the key being input is equal to or greater than the touch move sensitivity value set to the default value, the electronic device may identify a key at the touch-up position, which is a position where the touch input is in progress, as the input key, and process input of the key.

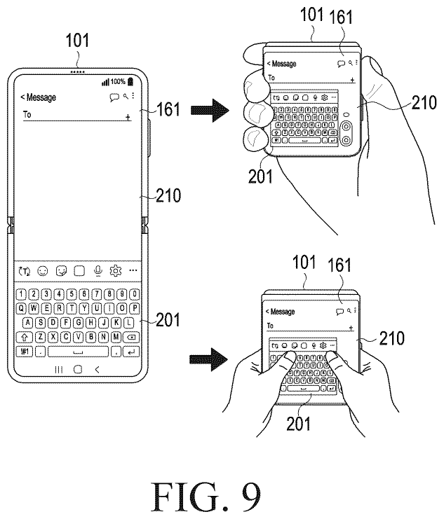

FIGS. 9, 10, 11, and 12 are diagrams illustrating reconfiguration of a keyboard layout based on a deformation state of an electronic device according to various embodiments of the disclosure.

Referring to FIGS. 9, 10, 11, and 12, when the form factor (e.g., a Z-flip, Z-fold, V-rollable, or slidable type) of the housing is deformed by folding or sliding of some portions of the housing, the electronic device 101 according to an embodiment may reconfigure the layout of a keyboard according to a change in the size of the display.

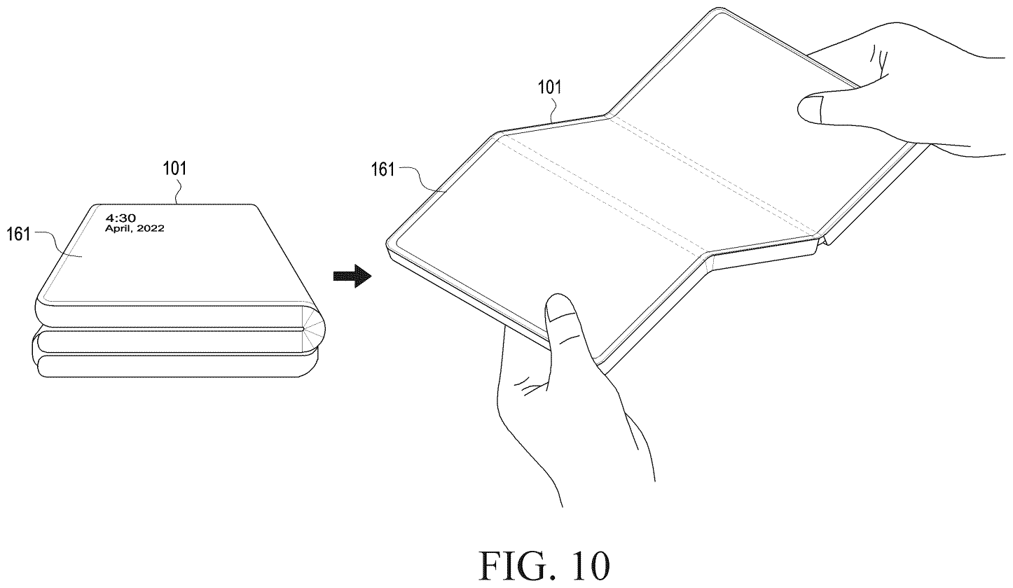

According to an embodiment, as the form factor (e.g., Z-flip or Z-fold) is deformed into the folded or unfolded state, the electronic device may reconfigure the layout of the keyboard 201, for example, as illustrated in FIGS. 9 and 10. The unfolded state may be changed to the folded state, and the layout of a pop-up keyboard 201 may be reconfigured by changing the keyboard from a QWERTY keyboard to the pop-up keyboard 201 in the folded state. The electronic device may identify whether the user's gripping style is one-hand grip or two-hand grip. Based on reception of a user's touch input, the electronic device 101 may collect and store the folded state, the two-hand grip or one-hand grip, the pop-up keyboard 201, a touch input position, and a touch duration as context data. In addition, other necessary information may be collected and stored. The electronic device may generate statistical data by analyzing movement of the user's touch input based on the collected context data, and adjust a touch move sensitivity value based on the generated statistical data, thereby identifying a correct input key for the touch input in a user-customized manner.

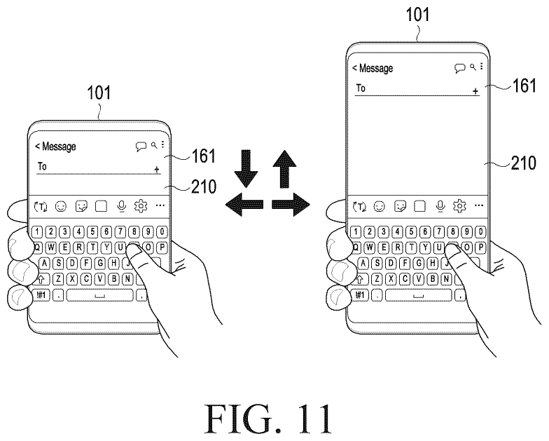

According to an embodiment, the electronic device may reconfigure the layout of a keyboard, when the housing is partially changed from a rolling-in state to a rolling-out state according to deformation of the form factor (e.g., V-rollable), for example, as illustrated in FIG. 11. For example, when a QWERTY keyboard is displayed, the layout of the keyboard may be reconfigured by changing the size of the QWERTY keyboard. The electronic device may identify whether the user's gripping style is one-hand grip. Based on reception of the user's touch input, the electronic device 101 may collect and store the rolling-out state, the one-hand grip, the QWERTY keyboard, a touch input position, and a touch duration as context data. In addition, other necessary information may be collected and stored. The electronic device may generate statistical data by analyzing movement of the user's touch input based on the collected context data, and adjust a touch move sensitivity value based on the generated statistical data, thereby identifying a correct input key for the touch input in a user-customized manner.

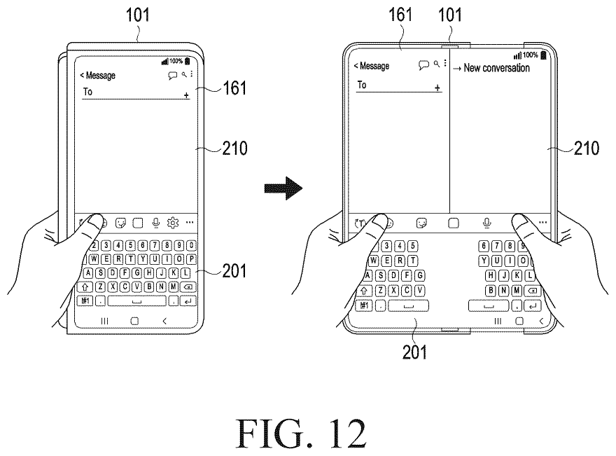

According to an embodiment, the electronic device may reconfigure the layout of a keyboard, when the housing is partially changed from a slide-in state to a slide-out state according to deformation of the form factor (e.g., slidable), for example, as illustrated in FIG. 12. As the slide-in state is changed to the slide-out state, the electronic device may reconfigure the layout of the keyboard by changing a QWERTY keyboard to a split keyboard. The electronic device may identify that the user's gripping style has been changed to a two-hand grip, as the slide-in state is changed to the slide-out state. Based on reception of the user's touch input, the electronic device 101 may collect and store the slide-out state, the two-hand grip, the split keyboard, a touch input position, and a touch duration as context data. In addition, other necessary information may be collected and stored. The electronic device may generate statistical data by analyzing movement of the user's touch input based on the collected context data, and adjust a touch move sensitivity value based on the generated statistical data, thereby identifying a correct input key for the touch input in a user-customized manner.

According to an embodiment, a method of operating an electronic device (e.g., the electronic device 101 of FIGS. 1 and 2) may include displaying the keyboard 201 on the display 161 of the electronic device in response to an application being executed.

According to an embodiment, the method may include, based on receiving a touch input from the keyboard, collecting context data related to the touch input and storing the collected context data in the memory 130 of the electronic device.

According to an embodiment, the method may include, based on the collected context data, generating statistical data of a key being input and storing the statistical data in the memory.

According to an embodiment, the method may include, based on the statistical data of the key being input, stored in the memory, analyzing movement of the touch input, and adjusting a touch move sensitivity value based on a result of the analysis.

According to an embodiment, the method may include, based on the adjusted touch move sensitivity value, identifying a key corresponding to a touch-down position or a touch-up position of the touch input as an input key.

According to an embodiment, the method may include processing input of a character corresponding to the input key.

According to an embodiment, the method may further include displaying the character corresponding to the input key in a partial area of the keyboard on the display.

According to an embodiment, collecting the context data related to the touch input and storing the collected context data in the memory may include obtaining the touch-down position, the touch-up position, and a touch duration of the touch input, identifying a type of the keyboard displayed on the display, identifying a user's gripping style using at least one sensor of the electronic device, and collecting and storing the touch-down position, the touch-up position, and the touch duration of the touch input, status information based on shape deformation of a housing, the type of the keyboard, and the gripping style as the context data.

According to an embodiment, generating the statistical data of the key being input and storing the statistical data in the memory may include, based on receiving the touch input, identifying the touch-down position and the touch-up position of the key being input, stored in the memory, obtaining a vector representing a touch movement direction and a touch movement distance from the touch-down position to the touch-up position, obtaining a scalar representing the touch movement distance from the touch-down position to the touch-up position, generating statistical data based on at least one of the vector or the scalar for the key being input, and storing the generated statistical data in the memory.

According to an embodiment, adjusting the touch move sensitivity value may include comparing at least one of the touch-down position or the touch-down-up position of the key being input with a center of a key press model, based on identifying that the touch-down position is closer to the center of the key press model, identifying that accuracy of the touch-down position is greater than accuracy of the touch-up position, and based on identifying that the touch-up position is closer to the center of the key press model, identifying that the accuracy of the touch-up position is greater than the accuracy of the touch-down position.

According to an embodiment, adjusting the touch move sensitivity value may include obtaining the statistical data for the key being input from the memory, based on the statistical data, obtaining collected vector values for the key being input and obtaining an average vector value of the collected vector values, based on the statistical data, obtaining collected scalar values for the key being input and obtaining an average scalar value of the collected scalar values, and based on the average vector value or the average scalar value, adjusting the touch move sensitivity value.

According to an embodiment, adjusting the touch move sensitivity value may include, when the average scalar value of the key being input for the touch input is equal to or greater than a first threshold distance, identifying that accuracy of the touch-down position is greater than accuracy of the touch-up position based on the touch-down position being closer to the center of the specified key press model, and adjusting the touch move sensitivity value to be equal to or greater than the first threshold distance.

According to an embodiment, adjusting the touch move sensitivity value may include, when the average scalar value of the key being input for the touch input is equal to or less than a second threshold distance, adjusting the touch move sensitivity value to be equal to or less than the second threshold distance.

According to an embodiment, adjusting the touch move sensitivity value may include, when the average scalar value of the key being input for the touch input is between the first threshold distance and the second threshold distance, adjusting the touch move sensitivity value to an interpolated value between the first threshold distance and the second threshold distance.

According to an embodiment, identifying the key corresponding to the touch-down position or the touch-up position of the touch input may include, when a touch movement distance of the key being input is less than a touch move sensitivity value set as a default value, ignoring movement after a touch-down, identifying a key corresponding to the touch-down position as the input key, and processing input of the key, and when the touch movement distance of the key corresponding to the position of the touch input is equal to or greater than the touch move sensitivity value set as the default value, identifying a key at the touch-up position, which is a position where the touch input is performed, as the input key, and processing input of the key.

According to an embodiment, in a non-transitory storage medium storing a program including executable instructions, when executed by a processor of an electronic device, the instructions may enable the electronic device to display the keyboard 201 on the display 161 of the electronic device in response to an application being executed, based on receiving a touch input from the keyboard, collect context data related to the touch input and store the collected context data in the memory 130 of the electronic device, based on the collected context data, generate statistical data of a key being input and store the statistical data in the memory, based on the statistical data of the key being input, stored in the memory, analyze movement of the touch input, and adjust a touch move sensitivity value based on a result of the analysis, based on the adjusted touch move sensitivity value, identify a key corresponding to a touch-down position or a touch-up position of the touch input as an input key, and process input of a character corresponding to the input key.

According to an embodiment, a typographical error that occurs due to slipping after a correct touch-down may be reduced, statistical data may be naturally collected without requesting an additional collection process from a user, while the user uses a keyboard, thereby generating user-customized statistical data, and a correct key may be input based on the statistical data. In addition, various effects that are directly or indirectly identified through the disclosure may be provided.

The embodiments disclosed herein are provided for the purpose of description and understanding of the disclosed technical contents, not intended to limit the technical scope of the disclosure. Therefore, the scope of the disclosure should be interpreted as encompassing all modifications or various other embodiments based on the technical idea of the disclosure.

The electronic device according to various embodiments may be one of various types of electronic devices. The electronic devices may include, for example, a portable communication device (e.g., a smartphone), a computer device, a portable multimedia device, a portable medical device, a camera, a wearable device, or a home appliance. According to an embodiment of the disclosure, the electronic devices are not limited to those described above.

It should be appreciated that various embodiments of the disclosure and the terms used therein are not intended to limit the technological features set forth herein to particular embodiments and include various changes, equivalents, or replacements for a corresponding embodiment. As used herein, each of such phrases as “A or B,” “at least one of A and B,” “at least one of A or B,” “A, B, or C,” “at least one of A, B, and C,” and “at least one of A, B, or C,” may include any one of, or all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively,” as “coupled with,” “coupled to,” “connected with,” or “connected to” another element (e.g., a second element), it means that the element may be coupled with the other element directly (e.g., wiredly), wirelessly, or via a third element.

As used in connection with various embodiments of the disclosure, the term “module” may include a unit implemented in hardware, software, or firmware, and may interchangeably be used with other terms, for example, logic, logic block, part, or circuitry. A module may be a single integral component, or a minimum unit or part thereof, adapted to perform one or more functions. For example, according to an embodiment, the module may be implemented in a form of an application-specific integrated circuit (ASIC).

Various embodiments as set forth herein may be implemented as software (e.g., the program 140) including one or more instructions that are stored in a storage medium (e.g., internal memory 136 or external memory 138) that is readable by a machine (e.g., the electronic device 101). For example, a processor (e.g., the processor 120) of the machine (e.g., the electronic device 101) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a complier or a code executable by an interpreter. The machine-readable storage medium may be provided in the form of a non-transitory storage medium. Wherein, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to an embodiment, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities, and some of the multiple entities may be separately disposed in different components. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

It will be appreciated that various embodiments of the disclosure according to the claims and description in the specification can be realized in the form of hardware, software or a combination of hardware and software.

Any such software may be stored in non-transitory computer readable storage media. The non-transitory computer readable storage media store one or more computer programs (software modules), the one or more computer programs include computer-executable instructions that, when executed by one or more processors of an electronic device individually or collectively, cause the electronic device to perform a method of the disclosure.

Any such software may be stored in the form of volatile or non-volatile storage such as, for example, a storage device like read only memory (ROM), whether erasable or rewritable or not, or in the form of memory such as, for example, random access memory (RAM), memory chips, device or integrated circuits or on an optically or magnetically readable medium such as, for example, a compact disk (CD), digital versatile disc (DVD), magnetic disk or magnetic tape or the like. It will be appreciated that the storage devices and storage media are various embodiments of non-transitory machine-readable storage that are suitable for storing a computer program or computer programs comprising instructions that, when executed, implement various embodiments of the disclosure. Accordingly, various embodiments provide a program comprising code for implementing apparatus or a method as claimed in any one of the claims of this specification and a non-transitory machine-readable storage storing such a program.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. An electronic device comprising:
a display including a touch screen;
memory storing one or more computer programs; and
one or more processors including processing circuitry communicatively coupled to the display and the memory,
wherein the one or more computer programs include computer-executable instructions that, when executed by the one or more processors individually or collectively, cause the electronic device to:
control the display to display a keyboard in response to an application being executed,
based on receiving a touch input from the keyboard, collect context data related to the touch input and store the collected context data in the memory,
based on the collected context data, generate statistical data of a key being input and store the statistical data in the memory,
based on the statistical data of the key being input and stored in the memory, analyze movement of the touch input and adjust a touch move sensitivity value based on a result of the analysis,
based on the adjusted touch move sensitivity value, identify a key corresponding to a touch-down position or a touch-up position of the touch input as an input key, and
process input of a character corresponding to the input key.

2. The electronic device of claim 1, wherein the one or more computer programs further include computer-executable instructions that, when executed by the one or more processors individually or collectively, cause the electronic device to:
control the display to display the character corresponding to the input key in a partial area of the keyboard.

3. The electronic device of claim 1, wherein the one or more computer programs further include computer-executable instructions that, when executed by the one or more processors individually or collectively, cause the electronic device to:
obtain the touch-down position, the touch-up position, and a touch duration of the touch input; and
collect the touch-down position, the touch-up position, and the touch duration of the touch input as the context data.

4. The electronic device of claim 1, wherein the one or more computer programs further include computer-executable instructions that, when executed by the one or more processors individually or collectively, cause the electronic device to:
based on a size change of the display in response to shape deformation of a housing of the electronic device, control the display to reconfigure and display a layout of the keyboard;
identify a type of the keyboard displayed on the display;
identify a user's gripping style using at least one sensor of the electronic device; and
collect status information based on the shape deformation of the housing, the type of the keyboard, and the gripping style as the context data.

5. The electronic device of claim 1, wherein the one or more computer programs further include computer-executable instructions that, when executed by the one or more processors individually or collectively, cause the electronic device to:
generate a key set based on the collected context data;
obtain a touch input collection corresponding to the key set; and
generate the statistical data based on the touch input collection.

6. The electronic device of claim 1, wherein the one or more computer programs further include computer-executable instructions that, when executed by the one or more processors individually or collectively, cause the electronic device to:
based on receiving the touch input, identify the touch-down position and the touch-up position of the key being input, stored in the memory;
obtain a vector representing a touch movement direction and a touch movement distance from the touch-down position to the touch-up position;
obtain a scalar representing the touch movement distance from the touch-down position to the touch-up position; and
generate statistical data based on at least one of the vector or the scalar for the key being input, and store the generated statistical data in the memory.

7. The electronic device of claim 1, wherein the one or more computer programs further include computer-executable instructions that, when executed by the one or more processors individually or collectively, cause the electronic device to:
compare at least one of the touch-down position or the touch-up position of the key being input with a center of a key press model;
based on identifying that the touch-down position is closer to the center of the key press model, identify that accuracy of the touch-down position is greater than accuracy of the touch-up position; and
based on identifying that the touch-up position is closer to the center of the key press model, identify that the accuracy of the touch-up position is greater than the accuracy of the touch-down position.

8. The electronic device of claim 1, wherein the one or more computer programs further include computer-executable instructions that, when executed by the one or more processors individually or collectively, cause the electronic device to:
obtain the statistical data for the key being input from the memory;
based on the statistical data, obtain collected vector values for the key being input and obtain an average vector value of the collected vector values;
based on the statistical data, obtain collected scalar values for the key being input and obtain an average scalar value of the collected scalar values; and
based on the average vector value or the average scalar value, adjust the touch move sensitivity value.

9. The electronic device of claim 8, wherein the one or more computer programs further include computer-executable instructions that, when executed by the one or more processors individually or collectively, cause the electronic device to:
when the average scalar value of the key being input for the touch input is equal to or greater than a first threshold distance, identify that accuracy of the touch-down position is greater than accuracy of the touch-up position based on the touch-down position being closer to the center of a specified key press model, and adjust the touch move sensitivity value to be equal to or greater than the first threshold distance;
when the average scalar value of the key being input for the touch input is equal to or less than a second threshold distance, adjust the touch move sensitivity value to be equal to or less than the second threshold distance; and
when the average scalar value of the key being input for the touch input is between the first threshold distance and the second threshold distance, adjust the touch move sensitivity value to an interpolated value between the first threshold distance and the second threshold distance.

10. The electronic device of claim 9, wherein the one or more computer programs further include computer-executable instructions that, when executed by the one or more processors individually or collectively, cause the electronic device to:
when a touch movement distance of the key being input is less than a touch move sensitivity value set as a default value, ignore movement after a touch-down, identify a key corresponding to the touch-down position as the input key, and process input of the key; and
when the touch movement distance of the key corresponding to the position of the touch input is equal to or greater than the touch move sensitivity value set as the default value, identify a key at the touch-up position, which is a position where the touch input is performed, as the input key, and process input of the key.

11. A method of operating an electronic device, the method comprising:
displaying a keyboard on a display of the electronic device in response to an application being executed;
based on receiving a touch input from the keyboard, collecting context data related to the touch input and storing the collected context data in memory of the electronic device;
based on the collected context data, generating statistical data of a key being input and storing the statistical data in the memory;
based on the statistical data of the key being input and stored in the memory, analyzing movement of the touch input and adjusting a touch move sensitivity value based on a result of the analysis;
based on the adjusted touch move sensitivity value, identifying a key corresponding to a touch-down position or a touch-up position of the touch input as an input key; and
processing input of a character corresponding to the input key.

12. The method of claim 11, further comprising:
displaying the character corresponding to the input key in a partial area of the keyboard on the display.

13. The method of claim 11, wherein collecting the context data related to the touch input and storing the collected context data in the memory includes:
obtaining the touch-down position, the touch-up position, and a touch duration of the touch input;
identifying a type of the keyboard displayed on the display;
identifying a user's gripping style using at least one sensor of the electronic device; and
collecting and storing the touch-down position, the touch-up position, and the touch duration of the touch input, status information based on shape deformation of a housing, the type of the keyboard, and the gripping style as the context data.

14. The method of claim 11, wherein generating the statistical data of the key being input and storing the statistical data in the memory includes:
based on receiving the touch input, identifying the touch-down position and the touch-up position of the key being input, stored in the memory;
obtaining a vector representing a touch movement direction and a touch movement distance from the touch-down position to the touch-up position;
obtaining a scalar representing the touch movement distance from the touch-down position to the touch-up position; and
generating statistical data based on at least one of the vector or the scalar for the key being input, and storing the generated statistical data in the memory.

15. The method of claim 11, wherein adjusting the touch move sensitivity value includes:
comparing at least one of the touch-down position or the touch-up position of the key being input with a center of a key press model;
based on identifying that the touch-down position is closer to the center of the key press model, identifying that accuracy of the touch-down position is greater than accuracy of the touch-up position; and
based on identifying that the touch-up position is closer to the center of the key press model, identifying that the accuracy of the touch-up position is greater than the accuracy of the touch-down position.

16. The method of claim 11, wherein adjusting the touch move sensitivity value includes:
obtaining the statistical data for the key being input from the memory;
based on the statistical data, obtaining collected vector values for the key being input and obtaining an average vector value of the collected vector values;
based on the statistical data, obtaining collected scalar values for the key being input and obtaining an average scalar value of the collected scalar values; and
based on the average vector value or the average scalar value, adjusting the touch move sensitivity value.

17. The method of claim 16, wherein adjusting the touch move sensitivity value includes:
when the average scalar value of the key being input for the touch input is equal to or greater than a first threshold distance, identifying that accuracy of the touch-down position is greater than accuracy of the touch-up position based on the touch-down position being closer to the center of a specified key press model, and adjusting the touch move sensitivity value to be equal to or greater than the first threshold distance.

18. The method of claim 17, wherein the adjusting the touch move sensitivity value includes:
when the average scalar value of the key being input for the touch input is equal to or less than a second threshold distance, adjusting the touch move sensitivity value to be equal to or less than the second threshold distance; and
when the average scalar value of the key being input for the touch input is between the first threshold distance and the second threshold distance, adjusting the touch move sensitivity value to an interpolated value between the first threshold distance and the second threshold distance.

19. The method of claim 18, wherein identifying the key corresponding to the touch-down position or the touch-up position of the touch input includes:
when a touch movement distance of the key being input is less than a touch move sensitivity value set as a default value, ignoring movement after a touch-down, identifying a key corresponding to the touch-down position as the input key, and processing input of the key; and
when the touch movement distance of the key corresponding to the position of the touch input is equal to or greater than the touch move sensitivity value set as the default value, identifying a key at the touch-up position, which is a position where the touch input is performed, as the input key, and processing input of the key.

20. One or more non-transitory computer-readable storage media storing one or more computer programs including computer-executable instructions that, when executed by one or more processors of an electronic device individually or collectively, cause the electronic device to perform operations, the operations comprising:
displaying a keyboard on a display of the electronic device in response to an application being executed;
based on receiving a touch input from the keyboard, collecting context data related to the touch input and storing the collected context data in memory of the electronic device;
based on the collected context data, generating statistical data of a key being input and storing the statistical data in the memory;
based on the statistical data of the key being input and stored in the memory, analyzing movement of the touch input and adjusting a touch move sensitivity value based on a result of the analysis;
based on the adjusted touch move sensitivity value, identifying a key corresponding to a touch-down position or a touch-up position of the touch input as an input key; and
processing input of a character corresponding to the input key.
